(19) United States
(12) Patent Application Publication
(10) Pub. No.: US 2006/0077944 A1
(43) Pub. Date: Apr. 13, 2006

(54) Backward compatible transmitter diversity scheme for use in an ofdm communication system

(75) Inventors: Monisha Ghosh, Chappaqua, NY (US); Xuemei Ouyang, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTROINCS N.V., EINDHOVEN (US)

(21) Appl. No.: 10/538,114

(22) PCT Filed: Dec. 8, 2003
(86) PCT No.: PCT/IB03/05808

§ 371 Date: Jun. 8, 2005

Related U.S. Application Data
(60) Provisional application No. 60/432,887, filed on Dec. 12, 2002.

(51) Int. Cl. H04B 7/208

(52) U.S. Cl. 370/344

(57) ABSTRACT

Disclosed is a system and method for providing backward compatible transmitter diversity in an orthogonal frequency division modulated (OFDM) communication system. According to one aspect of the invention, a method for providing backward compatible transmitter diversity includes the steps of: receiving an input data bit stream; transforming it into an OFDM symbol stream comprised of even and odd symbols; dividing the OFDM symbol stream into a first symbol sub-stream and a second symbol sub-stream; processing the first symbol sub-stream by a first processing block to output a first processed symbol sub-stream; processing the second symbol sub-stream by a second processing block to output a second processed symbol sub-stream; transmitting the first processed symbol sub-stream from a first diversity antenna; and transmitting the second processed symbol sub-stream from a second diversity antenna and both are transmitted over non-overlapping frequencies.

The present invention generally relates to the field of wireless communications. More particularly, the invention relates to a backward compatible transmitter diversity scheme for use in an OFDM system.

Wireless communication systems commonly include information carrying modulated carrier signals that are wirelessly transmitted from a transmission source to one or more receivers within an area or region. A major design challenge in wireless communication systems is to maximize system capacity and performance in the presence of interference, and a time-varying multipath channel. Multipath propagation is caused by the transmitted signal reflecting off objects near the transmitter and receiver and arriving at the receiver over multiple paths where each received signal varies from each other received signal in both amplitude and phase over time. Multipath fading makes reliable reception more difficult than in an additive white Gaussian noise (AWGN) channel. The presence of multipath can severely distort the received signal. In a multipath environment, the multiple copies of the transmitted signal can interfere constructively in some portions of the occupied bandwidth. In other portions of the occupied bandwidth, the multiple copies can interfere destructively at the receiver. This signal duplication causes unwanted variations in the received signal strength over the bandwidth. Diversity is an effective way to combat this problem. Currently, most diversity schemes are implemented at the receiver side, which combines the signals received from multiple antenna elements in the hope that the signals received from the different antennae do not experience fading at the same time. The signals obtained from the different antenna are combined at the receiver through techniques such as switch diversity and maximum ratio combining. For example, the current IEEE 802.11a standard refers to the use of a receiver side switch diversity scheme which provides a low cost solution. As is well known, switch diversity requires the use of multiple antenna elements at the receiver.

One drawback associated with employing switch diversity on the receiver side is that it is not cost effective in that each mobile station in the network must employ multiple antenna elements. A more cost effective solution is to implement transmitter diversity at the base station to combat multi-path fading at a low cost to mobile users. Transmitter diversity is a technique whereby a transmitter is provided with two or more (N) antennas. These N antennas imply N channels that suffer from fading in a statistically independent manner. Therefore, when one channel is fading due to the destructive effects of multi-path interference, another of the channels is unlikely to be suffering from fading simultaneously. By virtue of the redundancy provided by these independent channels, a receiver can often reduce the detrimental effects of fading.

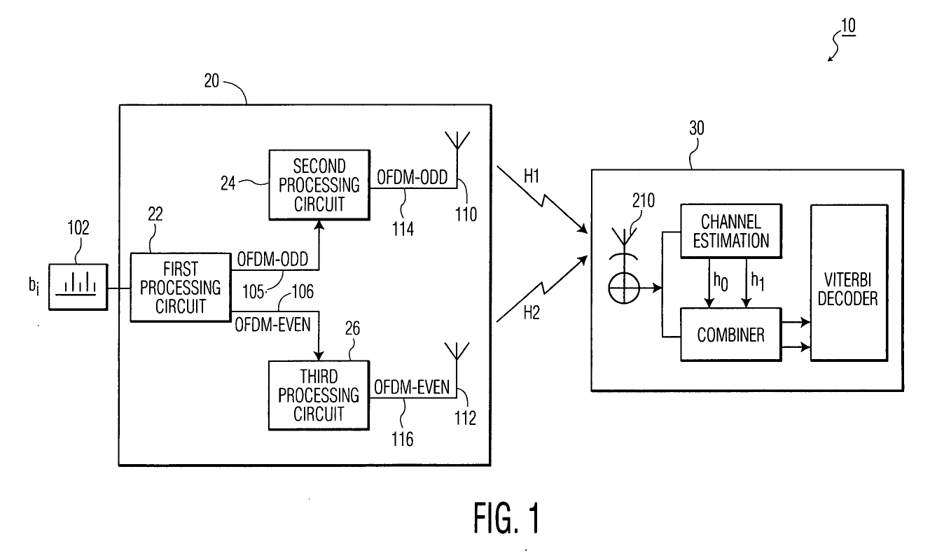

A basic transmitter diversity system with two transmitter antennas 10 and 11 and one receiver antenna 12 is illustrated in FIG. 1. By virtue of the redundancy provided by these independent channels, a receiver can often reduce the detrimental effects of fading.

To this end, the present invention is directed to a transmitter diversity scheme preferably for use in an IEEE 802.11a wireless communication system that is backward compatible with the existing OFDM systems. It is noted that the present invention finds primary, but not limiting, application in an 802.11a wireless communication system.

The present invention is directed to a method and system for providing backward compatible transmitter diversity in an orthogonal frequency division modulated (OFDM) communication system.

According to one aspect of the invention, a method is provided for providing backward compatible transmitter diversity. The method generally includes the steps of: receiving an input data bit stream; transforming the received input data bit stream into an OFDM symbol stream comprised of even and odd symbols; dividing said OFDM symbol stream into a first symbol sub-stream including only even symbols from said OFDM symbol stream and a second symbol sub-stream including only odd symbols from said OFDM symbol stream; processing said first symbol sub-stream by a first processing block to output a first processed symbol sub-stream; processing said second symbol sub-stream by a second processing block to output a second processed symbol sub-stream; transmitting said first processed symbol sub-stream from a first diversity antenna; and transmitting said second processed symbol sub-stream from a second diversity antenna; wherein said first and second OFDM symbol sub-streams are transmitted over non-overlapping frequencies.

According to another aspect of the present invention, there is provided a backward compatible transmitter diversity system. The system includes a first processing circuitry module for transforming an input data bit stream bi into an OFDM symbol stream; and dividing said OFDM symbol stream into a first and a second OFDM symbol sub-stream wherein said first OFDM symbol sub-stream is comprised of only even symbols from said OFDM symbol stream and said second OFDM symbol sub-stream is comprised of only odd symbols from said OFDM symbol stream; a second processing circuitry module for further processing said first OFDM symbol sub-stream; a third processing circuitry module for further processing said second OFDM symbol sub-stream; a first antenna for transmitting said further processed first OFDM symbol sub-stream; and a second antenna for transmitting said further processed second OFDM symbol sub-stream wherein said first and second OFDM symbol streams are transmitted over non-overlapping frequencies.

The invention provides a cost savings advantage by only requiring a modification to a transmitting node in the communication system without having to modify a plurality of receiving nodes. A further advantage of the invention is that it is backward compatible with existing OFDM systems.

The foregoing features of the present invention will become more readily apparent and may be understood by referring to the following detailed description of an illustrative embodiment of the present invention, taken in conjunction with the accompanying drawings, where:

FIG. 1 is a block diagram of an OFDM communication system including a single diversity receiver and a single non-diversity receiver;

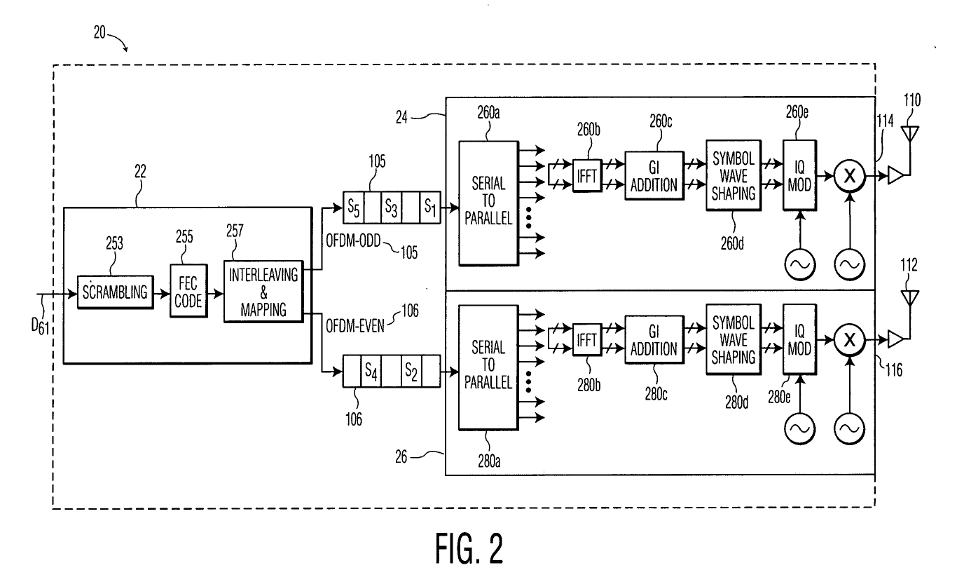

FIG. 2 illustrates a block diagram of a diversity transmitter's processing circuitry in accordance with one embodiment of the invention; and

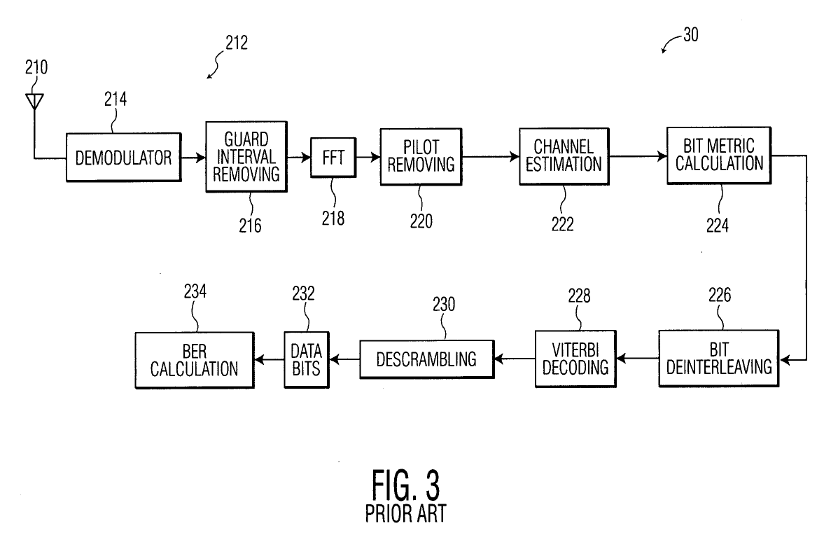

FIG. 3 illustrates an example of a wireless communication receiver according to the prior art.

In the following detailed description of the present invention, numerous specific details are set forth in order to provide a thorough understanding of the present invention. However, it will be apparent to one skilled in the art that the present invention may be practiced without these specific details. In some instances, well-known structures and devices are shown in block diagram form, rather than in detail, in order to avoid obscuring the present invention.

FIG. 1 illustrates, in block diagram form, a communication system 10 including a diversity transmitter 20 and a non-diversity receiver 30. Two separate propagation channels are shown, H1 and H2. The diversity transmitter 20 includes two antennae 110 and 112. In the diversity transmitter 20, a data bit stream, bᵢ, 102 is provided to a first processing circuitry module 22, from which two OFDM symbol streams OFDM-odd 105 and OFDM-even 106 are output. The first OFDM symbol stream, OFDM-even 105, includes only even OFDM symbols and is received by a second processing circuitry module 24 for processing therein. The second OFDM symbol stream, OFDM-odd 106 is made up of only odd OFDM symbols and is received by a third processing module 26 for processing therein. The processed OFDM-odd symbol stream 114, output from the second processing circuitry module 24 is passed on to antenna 110 for transmission over propagation channel H1 to be received by the non-diversity receiver 30. Similarly, the processed OFDM-even symbol stream 116 is output from the third processing circuitry module 26 and is passed on to antenna 112 for transmission over propagation channel H1 to be received by the non-diversity receiver 30. The non-diversity receiver 30 is conventional and will therefore be briefly described below.

It is noted that the embodiment of FIG. 1 includes only two diversity antennas. It is to be understood, however, that the invention may include more than two (N) transmit antennas to further enhance the robustness of the communication system 10.

Diversity Transmitter

FIG. 2 illustrates, in block diagram form, a more detailed description of the diversity transmitter 20 of FIG. 1. Data to be transmitted to a receiver is provided as input to the first processing circuitry module 22 as data bit stream, bᵢ. The initial data bit stream, bᵢ, to be transmitted can be, for example, a stream of data bits representing voice, video, or other data to be transmitted to the non-diversity receiver 30.

In the present embodiment, the first processing circuitry module 22 for processing the initial data bit stream, bᵢ, includes a scrambler 253, an FEC coding unit 255 and an interleaving and mapping unit 257, all of which are conventional. Of particular significance is the recognition that the interleaving and mapping unit 257 outputs two separate OFDM symbol streams, OFDM-odd 105 and OFDM-even 106 as described above. The even symbol stream 105 comprised of only even OFDM symbols and the odd symbol stream 106 comprised of only odd OFDM symbols.

In the embodiment, both processing circuitry modules 24 and 26 include identical processing circuitry. That is, both modules 24 and 26 include a serial-to-parallel converters 260a and 280a; inverse fast-fourier transform devices 260b and 280b; GI addition modules 260c and 280c; symbol wave shaping modules 260d and 280d; and IQ modules 260e and 280e.

The second and third processing circuitry modules 24, 26 are shown to be connected to respective transmission antenna 110 and 112.

Non-Diversity Receiver

FIG. 3 illustrates an example of a wireless communication receiver 250 according to the prior art in connection with an embodiment of the present invention. A key feature of the invention is that the transmission diversity scheme is transparent to the receiver thereby providing backward compatibility with existing receivers. In this regard, the receiver of FIG. 3 is conventional and will only be briefly described. An antennae 210 receives the transmission signals (even and odd symbol streams as modified by the transmission channel) sent by the antennae 110 and 112. The antenna 210 provides the received multi-carrier symbol streams to a first processing block 212 including conventional processing units, i.e., a demodulator 214, a guard interval removing unit 216, an FFT unit 218 and a pilot removing unit 220, a channel estimator 222, bit-metric calculation 224, bit deinterleaving 226, Viterbi decoding 228, descrambling 230, data bits 232 and BER calculation 234.

The foregoing is to be constructed as only being an illustrative embodiment of this invention. Persons skilled in the art can easily conceive of alternative arrangements providing a functionality similar to this embodiment without any deviation from the fundamental principles or the scope of this invention.

1. A diversity transmitter comprising:
(a) a first processing circuitry module for transforming an input data bit stream bi into an OFDM symbol stream and for dividing said OFDM symbol stream into a first OFDM symbol sub-stream and a second OFDM symbol sub-stream wherein said first OFDM symbol sub-stream includes only even symbols from said OFDM symbol stream and said second OFDM symbol sub-stream includes only odd symbols from said OFDM symbol stream;
(b) a second processing circuitry module, coupled to a first output of said first processing circuitry module, for further processing said first OFDM symbol sub-stream;
(c) a third processing circuitry module, coupled to said a second output of said first processing circuitry module, for further processing said second OFDM symbol sub-stream;
(d) a first antenna, coupled to an output of said second processing circuitry module, for transmitting said further processed first OFDM symbol sub-stream; and
(e) a second antenna, coupled to an output of said third processing circuitry module, for transmitting said further processed second OFDM symbol sub-stream;
wherein said first and second OFDM symbol sub-streams are transmitted over non-overlapping frequencies.

2. The diversity transmitter of claim 1, wherein said first processing circuitry module comprises a scrambler, an FEC encoder and an interleaving and mapping module.

3. The diversity transmitter of claim 2, wherein said interleaving and mapping module divides said OFDM symbol stream into said first OFDM symbol sub-stream and said second OFDM symbol sub-stream.

4. The diversity transmitter of claim 1, wherein the first and second antennas are spatially separated.

5. The diversity transmitter of claim 1, wherein said diversity transmitter operates in accordance with an IEEE 802.11a standard.

6. A diversity transmitter comprising:
means for transforming an input data bit stream bi into an OFDM symbol stream and for dividing said OFDM symbol stream into a first OFDM symbol sub-stream and a second OFDM symbol sub-stream wherein said first OFDM symbol sub-stream includes only even symbols from said OFDM symbol stream and said second OFDM symbol sub-stream includes only odd symbols from said OFDM symbol stream;
means for further processing said first OFDM symbol sub-stream;
means for further processing said second OFDM symbol sub-stream;
means for transmitting said further processed first OFDM symbol sub-stream; and
means for transmitting said further processed second OFDM symbol sub-stream;
wherein said first and second OFDM symbol sub-streams are transmitted over non-overlapping frequencies.

7. A method for transmitting an input symbol stream from a transmitting node in a wireless communication system, the method comprising the steps of:
(a) receiving an input data bit stream;
(b) transforming the received input data bit stream into an OFDM symbol stream comprised of even and odd symbols;
(c) dividing said OFDM symbol stream into a first symbol sub-stream including only even symbols from said OFDM symbol stream and a second symbol sub-stream including only odd symbols from said OFDM symbol stream;
(d) processing said first symbol sub-stream by a first processing block to output a first processed symbol sub-stream;
(e) processing said second symbol sub-stream by a second processing block to output a second processed symbol sub-stream;
(f) transmitting said first processed symbol sub-stream from a first diversity antenna; and
(g) transmitting said second processed symbol sub-stream from a second diversity antenna;
wherein said first and second further processed OFDM symbol sub-streams are transmitted over non-overlapping frequencies.

8. The method of claim 6, wherein said steps (f) and (g) are performed independent of each other.

9. The method of claim 6, wherein said step of processing said first symbol stream further comprises the steps of:
(a) performing a serial-to-parallel conversion on said first symbol sub-stream;
(b) performing an inverse fourier transform (IFFT) on an output from said step (a);
(c) performing a GI addition on an output from said step (b);
(d) performing a symbol wave-shaping on an output from said step (c); and
(e) modulating an output from said step (d).

10. The method of claim 6, wherein said step of processing said second symbol stream further comprises the steps of:
(a) performing a serial-to-parallel conversion on said second symbol sub-stream;
(b) performing an inverse fourier transform (IFFT) on an output from said step (a);
(c) performing a GI addition on an output from said step (b);
(d) performing a symbol wave-shaping on an output from said step (c); and
(e) modulating an output from said step (d).
